(19) United States
(12) Patent Application Publication
(10) Pub. No.: US 2014/0006077 A1
(43) Pub. Date: Jan. 2, 2014

(54) PROCUREMENT OF TASK SERVICES

(71) Applicant: Moose Loop Holdings, LLC, (US)

(72) Inventor: Ken R. Davis, Salt Lake City, UT (US)

(73) Assignee: Moose Loop Holdings, LLC, Salt Lake City, CA (US)

(21) Appl. No.: 13/707,918

(22) Filed: Dec. 7, 2012

Related U.S. Application Data
(60) Provisional application No. 61/569,599, filed on Dec. 12, 2011.

(51) Int. Cl. G06Q 30/06; G06Q 10/06

(52) U.S. Cl. CPC G06Q 30/0621; G06Q 10/06311
USPC 705/7.14; 705/7.13

(57) ABSTRACT

Technology is described for the procurement of task services. In one example, the tasks can be obtained in a single package, such as by the steps of displaying a plurality of tasks and high-level parameters related to the tasks; receiving input to configure the high-level parameters with respect to the tasks; incorporating meta-data parameters with the high-level parameters using the processor; determining a fixed price for performing one or more of the tasks using the processor; and receiving input from the customer for ordering one or more of the tasks. Other examples include inspection regimes for improving efficiencies.

### RELATED APPLICATION

This application claims the benefit of U.S. Provisional Patent Application Ser. No. 61/569,599, filed Dec. 12, 2011, which is incorporated herein by reference in its entirety.

### BACKGROUND

Many goods can be purchased in a commoditized way. A consumer can have certain criteria when deciding to purchase goods and if the goods meet desired criteria, then the consumer often does not care who provides the goods, making these certain types of goods a commodity. However, to consider the goods a commodity, there is often also a market offering to sell the goods. Typically, the market establishes a fixed price for the goods, at which point the goods can be obtained without bargaining, bidding, or auction.

Services have traditionally been less commoditized. Rather, services are typically purchased after comparing service providers to one another. For example, service providers can be compared through a bidding process, interviews, and/or online user feedback ratings. Even such service provider comparisons can be challenging for a consumer to interpret due to the non-uniformity in services supplied by various service providers and the unfortunate ability for the services providers themselves to “game” the systems (e.g. supplanting user feedback and ratings systems with their own self-serving feedback and ratings). This has resulted in uncertainty to the consumer as to the comparative cost of services, reliability of services, and the quality of services provided by service providers.

Another challenge associated with the sale and purchase of services can be found on the side of the service provider. Although consumers can readily compare the service providers and their respective offerings, inefficiencies relating to the actual servicing of the consumers can arise for the service provider. For example, a real challenge for service providers is that they are frequently competing on cost alone, and rarely on quality of service (which is more subjective and therefore harder for the customer to judge). The service provider also tends to waste a considerable period of time which could be used performing actual tasks or work, thereby increasing billable hours. If the average billable hours could be increased, the contractor could still work the same number of hours, but instead of spending time doing non-billable bidding and other customer management, the service provider could spend more time doing actual billable work.

### BRIEF DESCRIPTION OF THE DRAWINGS

FIG. 1 is a block diagram illustrating systems for allowing a customer to procure services in accordance with examples of the present disclosure.

FIG. 2 is a flowchart illustrating methods for allowing a customer to procure a plurality of tasks as a single package in accordance with examples of the present disclosure.

FIG. 3 is an exemplary visual display of one-time and recurring tasks as may be displayed on a computer screen in accordance with examples of the present disclosure.

FIG. 4 is a flowchart illustrating methods for allowing a customer to procure services with the assistance of an inspector in accordance with examples of the present disclosure.

FIG. 5 is a flowchart illustrating a more specific method for facilitating unit-turn in accordance with examples of the present disclosure.

FIG. 6 is a flowchart illustrating methods for assigning tasks to a single service provider in accordance with examples of the present disclosure.

### DETAILED DESCRIPTION

Reference will now be made to the examples described herein and illustrated in the drawings, and specific language will be used herein to set forth the same. It will nevertheless be understood that no specific limitation of the scope of the technology is thereby intended. Alterations and further modifications of the features described and illustrated herein which would occur to one skilled in the relevant art and having possession of this disclosure are to be considered within the scope of the description.

A technology is described for efficiently providing access to services via a networked computer system at fixed prices. More accurate and efficient access to services can be used to commoditize services not traditionally commoditized in the past by allowing the services to be priced and delivered in a more uniform fashion. Such access can be provided by operations implemented in networking and computing device hardware, such as generating a market of service providers for a user selected service from a pool of service providers, acquiring information about services on-line that are tailored to those service providers, and/or applying statistical pricing information from those service providers and/or additional sources. Additional operations can also be implemented to improve access to services at fixed prices. The improvements can have positive impacts for both the customer and the service provider. Furthermore, by generating such a market of service providers, acquiring information about services on-line tailored to those service providers, and/or applying statistical pricing information from those services providers and services, services not traditionally commoditized in the past can be commoditized.

While access may be provided for any of a nearly limitless number of services provided by service providers, examples of commoditization of services may be applied to many areas including various yard, home, or commercial building services, such as: lawn care (e.g., lawn mowing, lawn fertilizing, edging, etc.), basic home repairs, painting, cleaning, gardening, small appliance repair, snow removal, etc. A service provider can be any service provider, contractor, service contractor, service group, or service supply entity that provides a service to a customer. It is noted that though different types of yard work or apartment preparation examples are often described herein, the systems and methods can be related to any of a number of services, such as, for example, fertilize lawn, mow lawn, aerate lawn, edge lawn, remove debris, prune trees, spring/fall cleanup, pest control, clear snow, clear gutters, clean/maintain pool, collect garbage, wash windows, clean carpets, clean house, paint, evict a tenant, inspect a property, rekey locks, plumbing, electrical, HVAC, sprinklers, handyman services, etc.

This technology may allow a user to select a service or task (e.g., lawn mowing) to be purchased electronically, and a user interface on a client device can present choices to the customer that include task parameters and other details about the service. These service parameters can be used to provide efficient commodity-like pricing. The service parameters may include task details or variables that affect pricing and other factors for the task. In the lawn mowing example, parameters may be collected from a customer that can include: lawn shape and size, length of grass, type of grass, physical location, quality of service provider desired, need for repeat service, etc. Other types of services will have other parameters, as would be appreciated by a service provider. The pricing of the service or task may be a fixed price that is calculated using existing facts about the service and statistical data known about task prices in a geographical area, etc. With iterated services and sufficient service provider and customer feedback, the pricing can become more accurate over time such that each task may become more like a standard unit of work that is priced with increasing accuracy.

Commoditized tasks purchased by a customer through this technology may be matched with one of a plurality of service providers who have schedule availability to perform the task. Customers may have the opportunity to select preferred service providers from a list of available service providers, but the selection of a service provider is optional. A customer may be encouraged to allow the service provider to be assigned automatically using a computing device, and the customer may be encouraged not to select a service provider through various pricing and other inducements. As the services become more commoditized, then the service providers become more easily interchangeable. This may provide an experience similar to a customer's experience in a retail setting where the customer is more interested in the availability, proximity, reliability, and the quality of the goods received than which individual made the goods being purchased.

Service providers can be matched to customers on the basis of a number of additional parameters identified by the service providers and these parameters may include: shortest distance to customer from the service provider's base location or from one or more of a service provider's existing customers, higher schedule availability, matching skill level, quality level desired, and/or other parameters. The value provided to service providers may be increased by providing more customers, assigning customers situated closer together, automated pricing, back office accounting and management functions, and other ways that improve service provider efficiency and/or boost service provider revenues.

Using a commodity approach can simplify the service purchase process and can make buying services more analogous to buying tangible goods through a retail store. Detailed methods may be used to compute fair market pricing for the service based on customer provided specifications about the service to be performed. The fair market pricing can allow a fixed price to be presented to the customer, at the point of sale, and allow the customer to complete a transaction immediately.

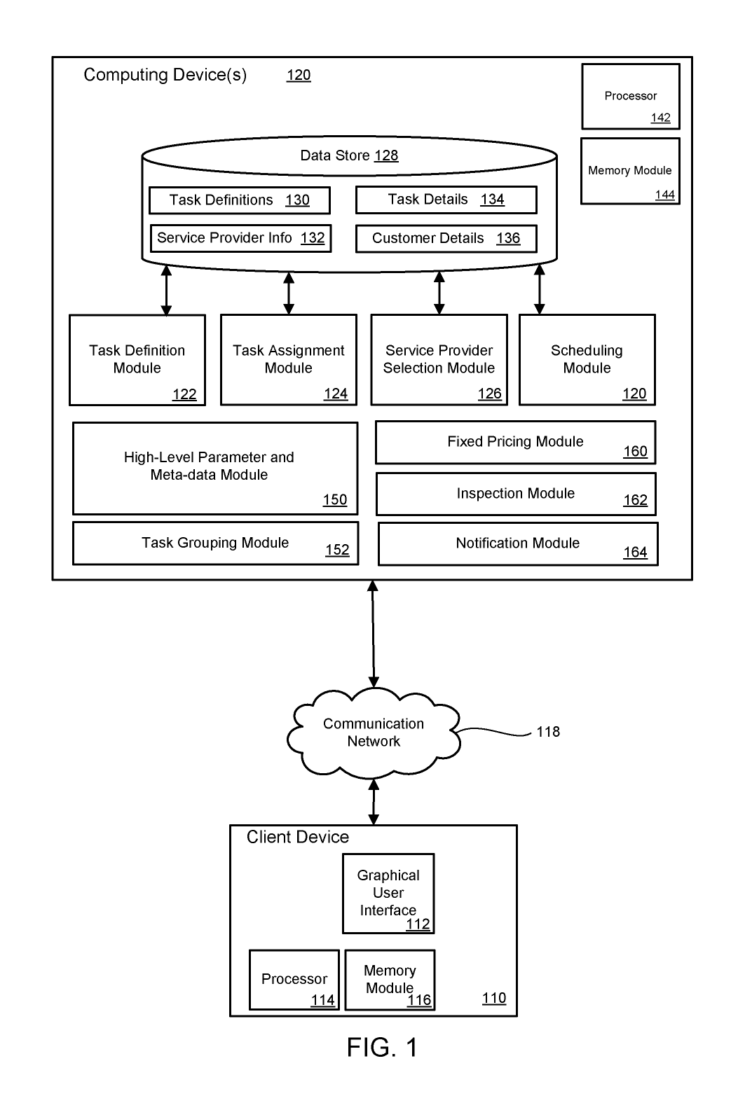

As illustrated in FIG. 1, a system for allowing a customer to procure services is provided. It is noted that not all modules or other system features are required for each method of the present disclosure. These features, information, and modules are provided merely for convenience to show an example system that can work over multiple methods described herein. For example, an inspection module is shown, but inspection is not necessarily required for certain methods.

That being understood, the system may include a client device 110 through which a user can access information related to tasks and customers over a communications network 118. The communications network can be a local area network (LAN), wide area network (WAN), or the internet, for example. A graphical user interface 112 can be provided to the user using the client device 110 to access the task, customer, and related information located on a separate computing device 120. A client device 110 with a graphical user interface 112 may be used by either a service provider or a customer.

Parameters for a task that the customer desires to be performed can be received by the graphical user interface 112 of the client device 110. For example, the customer may type, speak, write, or select task parameters that the client device 110 can capture. Payment for the task selected by the customer may also be supplied via the graphical user interface. In one example, payment via a credit card or debit transaction is collected before the task is assigned to a service provider for performance. The client device may include a processor 114 and a memory module 116. A client device 110 may be a device such as, for example, a desktop computer, a laptop, a tablet, a mobile device, a television, a cell phone, a smart phone, a hand held messaging device, a set-top box, a gaming console, a personal data assistant, an electronic book reader, heads up display (HUD) glasses, or any device with a display that may present the graphical user interface 112.

The parameters for a task collected by the client device 110 can be sent to a computing device 120. The computing device 120 may be provided with modules for providing and managing tasks and customers. Additional related functions for communication, service provider selection, customer reassignment or exchange, task exchange, task grouping with a single service provider, proximity assessments, and customer valuation, can also be provided. The computing device 120 may be a single server, a distributed server environment, a server farm, or any computing device or group of computing devices that may service requests from other computing devices or programs. In addition, the computing device may include one or more processors 142 and memory modules 144.

The parameters that are requested from the customer can be collected and used by a task definition module 122. The task definition module 122 can also obtain a task definition for a task which describes task details to be performed for a customer. In addition, the task definition module 122 can access the task definitions 130 located in the data store 128, and the task definitions may include specific definitions of what procedures are going to be undertaken for a task. For example, the task definition can define a mowing job as: 1) cutting grass, and 2) blowing loose grass off sidewalks. The task definition may also include a question template to send to customers to obtain the factual task parameter information that is desired to be captured from the customer about a task type. The customer's replies and specific factual data collected in response to the questions about tasks can be stored in the task details 134 data store. The data store 128 can also receive and store service provider information 132 as well as customer details 136 to be accessed and updated when applicable. The data store 128 may refer to any device or combination of devices capable of storing, accessing, organizing, and/or retrieving data, which may include any combination and number of data servers, relational databases, object oriented databases, simple web storage systems, distributed storage systems, data storage devices, data warehouses, flat files, and data storage configuration in any centralized, distributed, or clustered environment. The storage system components of the data store may include storage systems such as a SAN (Storage Area Network), cloud storage network, volatile or non-volatile RAM, optical media, or hard-drive type media, for example.

Additional input parameters related to the customer may also be obtained automatically from third parties. For example, information associated with the tasks such as a house lot size, square footage of the house, number of bedrooms and bathrooms, and related real property information can be obtained for a real estate information service provider. Similarly, mapping data and address correction data can be obtained from a mapping information service provider. Weather data can be obtained (e.g., for snow clearing predictions) including snow accumulation hourly actual measurements along with future predictions, temperature and humidity for estimating snow ablation from a weather information source.

Each task can be assigned using task details 132, service provider information 132, and/or customer details and 136 utilizing the task assignment module 124 and the service provider selection module 126. Scheduling can be determined using a scheduling module 120. The customer details 136 can include information related to the task(s) associated with the customer, the frequency of performance of each task, the timeliness of past payments from the customer for tasks performed, the length of time the customer has been a customer, the number of other tasks the customer has order in the past, or any measures related to the quality of the customer.

Thus, the scheduling module 120 can work together with the task assignment module 124 and the service provider selection module 126 to assist in selecting and assigning tasks to a service provider. Meta-data can also be used for this process, such as by implementing a high-level parameter and meta-date module 150 that receives, stores, and uses this type of data to make intelligent choices regarding assigning service providers to specific tasks. This is particularly useful when used in concert with a task grouping module 152 that groups task according to various parameters described herein. In combination with setting the tasks in appropriate groups, a fixed pricing module 160 can be used to set the fixed prices of the services. High-level data can include information such as frequency of service or quality of service, or can include a sporadic service preference based on environmental or other unpredictable conditions, such as weather-related conditions. Meta-data can be information that is fixed and known or becomes fixed and know, and once specified or collected, can be used over and over again.

Service provider feedback about customers can be useful in the process of assigning and grouping tasks for various service providers. To illustrate, in some cases, there may be unexpected aspects of a task that occurs with certain customers or certain types of tasks for the customers. For example, edging a customer's lawn may be more difficult the first time where the customer has a very overgrown lawn. Customer feedback about service providers (quality, timeliness, speed, etc.) and/or or service provider feedback about the customer (timeliness of payment, ease of accomplishing task based on customer cooperation, etc.) may also be used to refine the task assignment for a service provider.

As mentioned, matching a service provider with a customer can be carried out utilizing the task assignment module 124, the service provider selection module 126, and the scheduling module 120. Criteria for selecting service providers may include using at least one of the following: a distance between the service provider and customer, distance between the potential new service providers customers and the customer being traded, time slots made available by the service provider, a skill level of service requested, previous performance feedback of the service provider from prior customers, quality tier of a service provider, etc. Other criteria or metrics about service providers may also be used in selecting a service provider, as desired. On a related note, relative proximity or other parameters with respect to customers and each potential service provider can be assessed using a task grouping module 152, for example.

The customer and/or the service provider can be notified of the service to be conducted using a notification module 164. Notification to the service provider will occur so that the service provider knows of the task to be completed. However, notification to the customer can be optional, as the customer may or may not care what service provider is completing the task. That being stated, in one example, the notification module may prepare a web page or a web application page to be sent to the service provider and/or the customer. Alternatively, a notification can be sent through the graphical user interface 112 on the client device 110 using an application on the client device 110. Other types of notifications may include: emails, instant messages, text messaging, or any other message type that can be received by the customer or service provider.

An additional aspect of the system shown in FIG. 1 is that of inspection. Thus, there can be an inspection module 162 that manages inspection criteria and details, as well as instructions and notification to service providers and/or customers. For example, the inspection module 162 can be used to receive input from the inspector that the one or more tasks were properly performed, and this can be reported to the customer (e.g., project manager, owner, etc.) for approval and payment. Alternatively, the inspection module 162 can be used to remediate work that was not completed or completed at less than industry standards. In this example, the inspection module 162 can receive input from the inspector indicating that the one or more tasks were not properly specified, not performed, or not properly performed, and the module could be used to create one or more remediation procedures to remedy any of the one or more tasks that was not properly specified, not performed, or not properly performed. Furthermore, it is noted that the inspection module can be used for any of a number of tasks that would benefit from inspection, e.g., evaluating what is needed to prepare a rental property for a new tenant, evaluate what is needed for a possible maintenance and repair services, etc.

For each logical grouping of tasks or other task assignments, a computer system, such as the one described above in FIG. 1, can provide a singular dashboard for configuring the schedule of performance of the tasks, pricing the tasks, and configuring the specific parameters regarding the tasks, etc.

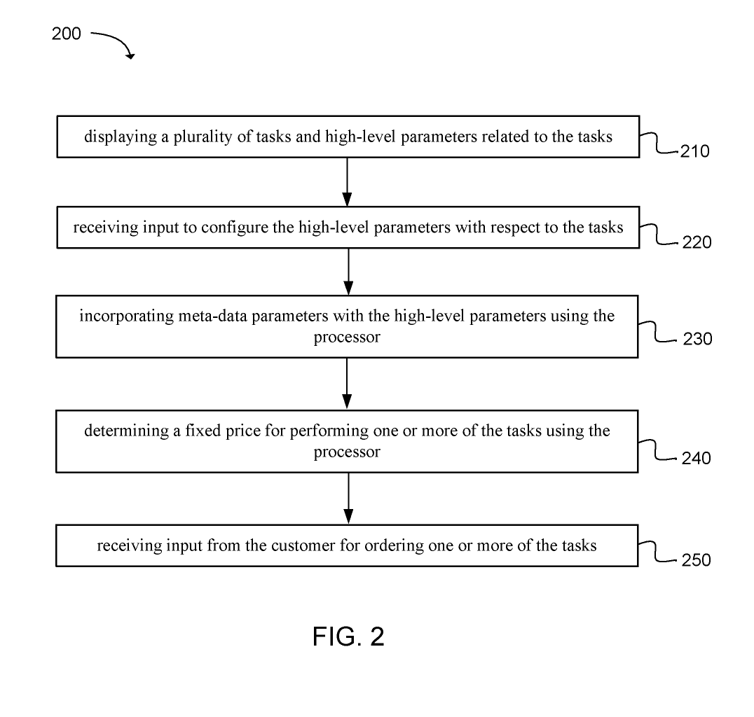

Using this system, for example, in accordance with FIG. 2, a method 200 for allowing a customer to procure tasks as a single package is provided. The method can include steps of displaying 210 a plurality of tasks and high-level parameters related to the tasks; receiving 220 input to configure the high-level parameters with respect to the tasks; and incorporating 230 meta-data parameters with the high-level parameters using the processor. Additional steps can include determining 240 a fixed price for performing one or more of the tasks using the processor; and receiving 250 input from the customer for ordering one or more of the tasks. In one example, the tasks are related to one or more properties that are also displayed along with the tasks and high-level parameters. However, this system is not necessarily only usable for tasks related to properties. It can also be used to manage task for commercial services, such as building services for industries including construction, the oil industry (shale oil extraction, crude/sand/water deliver/recovery), etc. Thus, many examples here will discuss “property,” but that is for exemplary purposes only. Other industries that have little to do with property can also benefit from the present systems and methods.

In these examples, the high-level parameters can include the frequency of service or quality of service, or can include a sporadic service preference based on environmental or other unpredictable conditions, such as weather-related conditions, tenant vacancy, etc. Furthermore, in the case of property management, a property list might be generated that can include a list of multiple properties, a list of units within a single property, or a list of units over multiple properties, for example.

As mentioned, one advantage of this method in the property management or other service industry is that it allows for tasks to be facilitated individually or collectively over a reduced time interval, with minimal time investment with the project manager, e.g., property manager in the case of property management. For example, tuning a rental property can be more efficient and less time consuming. In other words, typically, preparing a unit is done by a single maintenance person, plus a handful of outside service providers. The maintenance person might be responsible for a plurality of tasks including such things as: washing the windows, housecleaning, touch up painting, carpet cleaning, fixing plumbing leaks, fixing or replacing appliances, and/or replacing or rekeying locks. Typically, this can be inefficient. However, with the systems and methods of the present disclosure, the time it takes to prepare a rental unit to re-rent (referred to herein as “unit-turn”) can be reduced. This is particularly the case when a plurality of tasks include the same task repeated over multiple properties or multiple units, and this can be scheduled and managed using the methods and systems described herein.

To illustrate further, a plurality of properties and/or units of properties can be selected. These properties and/or units of properties can be assigned to one or more groups for ease of configuration when the number of properties and/or units of properties is large. Thus, tasks can be assigned to properties from a property list or group, e.g., individual properties and/or units of property and/or groups of properties and/or units of properties that have been selected. Before a task is assigned to property group, parameters about the task can be configured. These parameters can include such things as: the frequency of service (e.g. weekly in the event of lawn mowing, monthly in the event of filter changing, semiweekly in the event of pool cleaning); the desired tier or level of service; and specific preferences (e.g. plow when snow falls in excess of 2 inches, include salt or ice melt).

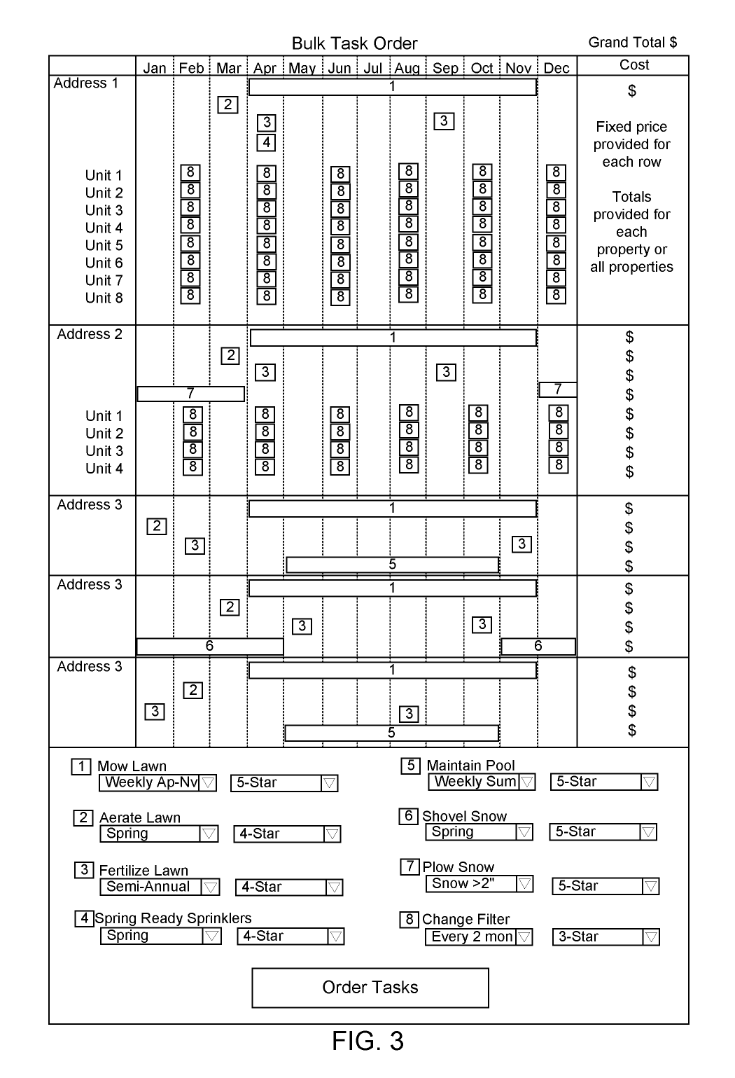

Once the tasks are configured, they can be selected with a mouse click and dropped onto an annual or other time-frame calendar next to the properties groupings that were selected. This can result in a visual display of the one-time and recurring tasks according to the configured parameters. In one example, the data can be displayed as shown in FIG. 3, where each row of data may correspond to one task being performed on one property group selected, e.g., individual property and/or unit of property and/or group of properties and/or units of properties. Further, columns next to these task rows may likewise be used to indicate the unit cost of each task, and the annual cost of having the task performed according to the recurring schedule specified in the parameters.

The calculation of fixed annual pricing for each task can be updated automatically if the parameters are modified. In this manner, the customer can tune the tasks to meet his or her budget. A grand total for all properties selected, e.g., individual properties and/or units of property and/or groups of properties and/or units of properties, can then also be displayed and updated each time parameters are modified. Thus, a cost per row (task) can be shown in one of the columns, and a grand total for each property and all properties can likewise be shown. In the example shown in FIG. 3, an annual view is shown, but other time intervals can also be selected for viewing.

Once one or more or all of the tasks are configured on a screen, such as that shown in FIG. 3, also referred to as a “bulk task order screen,” the customer can then click on an “order tasks” button to complete the order. The computer system can then automatically invoke the scheduling and the shortest distance optimization routines described elsewhere in this document to locate the best service providers to perform the work on the schedule requested by the customer. The customer can likewise be prompted for payment of all tasks, or for just the immediate set of tasks to be performed. For example, the payment information can be stored so that payment can be collected just prior to each subsequent task.

Once the tasks are scheduled with the corresponding service provider, the specific service provider details can be made available to the customer. This allows the customer to communicate directly with the service provider in the event of a problem. The customer can continue to use the computer system to make changes to these tasks as needs arise. Also, the customer can be notified when the service provider completes each task or if a service provider fails to complete a task. In the event of a failure, a remediation processes may likewise be invoked which results in either the existing service provider returning to perform the work as required, the existing service provider rescheduling the work to be performed, or a new service provider assigned to perform the work. In one example, it may be beneficial to set the system up so that the service provider does not receive payment for the work until the customer has had a window of time to accept or reject the work.

In accordance with this, the customer can also provide positive or negative feedback regarding the timeliness, the professionalism, and/or the quality at which the work was performed. This feedback can be incorporated into a rating system that may enable the service provider to be promoted or demoted in the computer system. Promotions can likewise be rewarded with higher rates of pay, more convenient scheduling, more customer opportunities, and/or other rewards. Demotions can also result in lower rates of pay, less customer opportunities, and in the case of serious failures, ejection from the computer system.

To provide an additional example related to unit-turn and/or bundling of other tasks, one can consider a situation where a task or group of tasks if performed on a regular basis. For many rental units each year and other highly repetitive tasks, there is almost no part of a unit-turn or other repetitive service that cannot be described and priced very accurately, and the time to perform the work also estimated very accurately. If the inspector is experienced, he/she will quickly be able to report that the present state of the task to be completed. With specific reference to unit-turn, for example, if a paint job is a 2 on a scale of 1 to 10 and the inspector knows from the customer's preferences that the paint should be brought to an 8 or greater, he/she can order the work to be completed. The inspector might also knows that there are 1,525 square feet of walls in 4 bedrooms, a living room, 2 bathrooms, and a kitchen that need to be painted, and that 2 tone paint is required. Using a “best fit” model from potentially hundreds or even thousands of prior painting tasks, the computer system can calculate that a task of the scope described by the inspector in the market in which the rental unit is present, and that it should cost approximately X amount of dollars, e.g., $623.00. Thus, when the painting service provider is hired, he is told that is the value of the work he is to perform and he can choose to “take it or leave it.” Then, when the inspector returns to verify quality of work, if the work was not properly performed, the customer can choose to (1) reject the work and have the service provider return to try again; (2) partially accept the work, pro-rating the payment the contract receives based on the work actually performed; or (3) request some type of other remediation such as replacing the service provider.

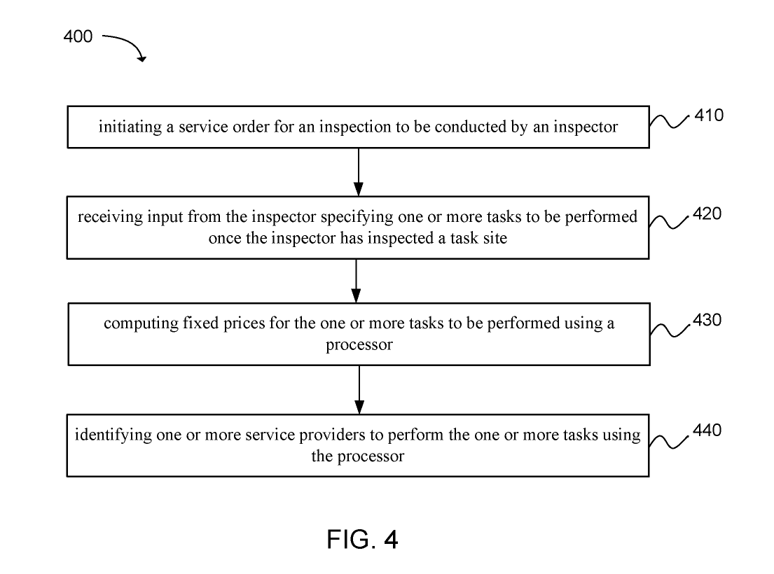

In a related example, a method 400 for allowing a customer to procure services with the assistance of an inspector comprising multiple steps, as shown in FIG. 4. The method can include steps of initiating 410 a service order for an inspection to be conducted by an inspector; receiving 420 input from the inspector specifying one or more tasks to be performed once the inspector has inspected a task site; computing 430 fixed prices for the one or more tasks to be performed using a processor; and identifying 440 one or more service providers to perform the one or more tasks using the processor. In one example, the step of obtaining approval from the customer to perform one or more tasks after receiving input for the inspector can likewise be included in the method.

Optional steps can include receiving input from the one or more service providers indicating that the one or more tasks have been completed; and notifying the inspector to return to the work site once the one or more tasks have been completed to verify that the one or more tasks have been properly performed. Other optional steps include receiving input from the inspector that the one or more tasks were properly performed, or alternatively, that the one or more tasks were not properly specified, not performed, or not properly performed. If the latter is the case, then an additional step of creating one or more remediation procedures to remedy any of the one or more tasks that was not properly specified, not performed, or not properly performed can be carried out. In another optional example, service providers (other than inspectors) can report the work of other service providers when work has not been completed, e.g., not started or performed to less than industry standards. In these methods, steps of receiving input from the one or more service providers indicating that a second service provider has not completed a task and automatically notifying the second service provider to return to complete the task properly can be carried out. In this example, an additional step of automatically rescheduling a task for the one or more service providers can be carried out if this task is to be sequentially carried out after the second service provider completes their task. For example, if a carpet cleaning service provider shows up and notices that the painter has not yet finished. He can then stop there, specify the problem, and this could automatically notifying the painter to return to perform the work. Additionally, this action can also automatically reschedule the carpet cleaning service provider to come back at a later time (after the painter is, in fact, finished). This system may optionally notify the customer so that the customer knows that the unit is not yet ready to be rented (or for some other workflow or practical reason).

The step of computing fixed prices can be based on one or more of the following: data provided by the inspector, data provided by the customer, and/or third party data that is obtained about the task. Examples of third party data that can be collected and used includes information about the weather, information from the government, such as from tax rolls, etc.

Once the tasks are identified, such as by the inspector, the tasks can be ordered for performance according to industry standards and expectations. For example, industry standards can be those that are predetermined based on known standards, or can be determined by data collected as the system of the present disclosure learns. Typically, however, the industry standards are generally known and can be described or set forth upon carrying out of the initial inspection. In addition to industry standards, the inspector can likewise specify an order in which the one or more tasks are to be performed as the order relates to at least two specific tasks. Furthermore, to avoid self-dealing by the inspector, the system can be set up so that the inspector performing the inspection is not permitted to be a service provider for certain tasks or even all of the work tasks.

It is noted that the present disclosure describes in some detail information about “service providers.” Additionally, in some examples, a specific type of service provider is described that is referred to as an “inspector.” Typically, the inspector performs tasks that relate only to inspection of property and setting up other service providers to carry out specific tasks or groups of tasks.

In further detail, as mentioned, there are a variety of instances were a task or groups of tasks cannot be performed until somebody has performed a visual or other type of inspection. In one example, the computer system can provide a methodology for allowing this inspection to occur as just one more fixed price task being offered by the computer system for customer purchase. This allows a complex set of additional tasks to be configured, fairly priced, performed, quality verified, and paid for with minimal additional involvement from the customer or service provider (other than conducting the actual task).

To illustrate, one can consider a property management scenario, although the same concept could be applied to many different services industries. One of the greatest challenges for a project manager, such as a property manager, is preparing a residence to be occupied by a new tenant. This process can be referred to as “unit-turn,” as previously mentioned and defined. Some of the difficulties include: (1) service providers are not always accountable for the time they take to perform a unit-turn, nor are they always accountable for the quality with which the unit-turn is performed; (2) scheduling a large number of specialized service providers for mostly small tasks, all of which need to be completed (sometimes in order) for the unit-turn is very inefficient and frequently results in delays to unit-turn completion, which subsequently has an impact on rent collections because the new tenant cannot move in until the unit is completed; and (3) service provider collusion is rampant because service providers stand to gain more when they refer business to each other rather than find the best value for the owner.

A sophisticated computer system can help to resolve many of these problems by continually analyzing pricing and logistical data to keep service providers on task, verify that tasks are completed on time, and verifying quality levels meet or exceed expectations. One of the basic ways that a computer system can increase the efficiency of customers and service providers is to provide a single interface where a plurality of complex tasks can be described, their price specified, and the tasks assigned and scheduled to one or more service providers. Thus, a unique type of service provider, i.e. the inspector, can be beneficial in starting and keeping the tasks moving efficiently.

A simple example of inspector that is commonly used today relates to a service provider who requires a service charge to inspect a job. For example, a service provider often charges a flat rate to inspect a problem, and provide an estimate for the labor, and materials required to perform the work. This is common, for example, when calling a plumber to the house or other property. Unfortunately, the use of the service charge in common practice has a built in conflict of interest where the person that will be doing the work is the very person who identified the problem or other work to be conducted. This means that the service provider stands to profit when the inspection results in a higher estimate of labor and materials. In accordance with examples of the present disclosure, the inspector dispatched by the systems and methods described herein, in some embodiments, are not allowed to perform the work or other tasks that they inspect and in some cases order.

In the example of a unit-turn, the inspector may be responsible for describing more than just one task, which might be performed by more than just one service provider. Before the unit-turn inspector can describe tasks to be performed, specific meta-data about the unit to be turned may be provided to the computer system. Alternatively or additionally, any missing meta-data can likewise be added or completed by the inspector on-site. This meta-data may fall into two or more categories: facts about the unit to be turned, and owner or property manager preferences about how the unit should be turned. Facts about the unit may include such things as: square footage, number of bedrooms, number of bathrooms and other rooms, lot size, age of property, linear/square/volume measurements, etc. Preferences include such things as: color of paint, style of carpet, make/model of appliances, standard property, etc.

For many complex task groups, like would typically occur for a unit-turn, there are groups of likely tasks that should be performed, and sometimes in a specific order, e.g., paint walls before replacing or cleaning carpet. Thus, the computer system can be programmed with preconceived groups of tasks for the inspector to describe. In the case of the unit-turn, these tasks include such things as: re-carpeting, touchup painting, carpet cleaning, appliance replacement, cabinetry replacement, re-flooring of bathroom or kitchen tile or linoleum, repair or replacing light fixtures, repair or replacing outlets, repair or replacing faucets, rekeying or replacing locks, repairing or replacing broken or out of date windows, housecleaning, etc.

Furthermore, as mentioned, in any group of tasks to be specified by the inspector, there might be a logical order in which selected tasks should be performed. This is because certain tasks, like housecleaning, which might be cleaning up other tasks are performed after those other tasks. Similarly, tasks like cabinetry replacement, should logically be performed after related tasks like re-flooring. The computer system keeps track of the logical ordering of such tasks and only allows them to be scheduled with various service providers in their proper order.

Additionally, there are many smaller tasks that would be inefficiently performed by multiple service providers. Because of this, the computer system can include logic that combines these smaller tasks into units of work to be performed by individual service providers. These smaller tasks can then be combined using a variety of different techniques. For example, each service provider specifies the types of tasks he or she is qualified to perform. When multiple tasks are required for a single project like the unit-turn, the computer system automatically matches the greatest number of individual tasks with service providers that have the expressed capability of performing those tasks. The computer system also verifies that the service provider has sufficient time availability to perform those tasks and either schedules the next available service provider capable of performing those tasks, or if there is not a single service provider with schedule availability prior to the desired date of completion, the computer system can attempt to divide up the tasks across multiple service providers with time availability before the desired date of completion.

As each service provider completes his scheduled task(s), he or she can then document the task performed, including the start and end time and any comments related to the work, and take one or more digital photographs which may be uploaded to the computer system of the work performed. This documentation can be reviewed by the inspector or by the property owner/customer/manager.

It should be noted that the computer system can use pricing models based on historical data to generate fixed pricing for each task so that individual service provider bidding is typically not required. Furthermore, the independence of the inspector allows for the computation of fair pricing that is not being influenced by either the customer or the service provider performing tasks.

Once all service provider tasks for a group of tasks like the unit-turn are completed, the inspector may return to verify the completion and quality of the work. If any task was not completed at the quality levels specified by the facts and preferences of the property owner/customer/manager, then the inspector can reject the task. This results in the computer system rescheduling a follow-up effort by the service provider to redo or otherwise remediate the work product or task. Only once the work is performed properly is the service provider paid.

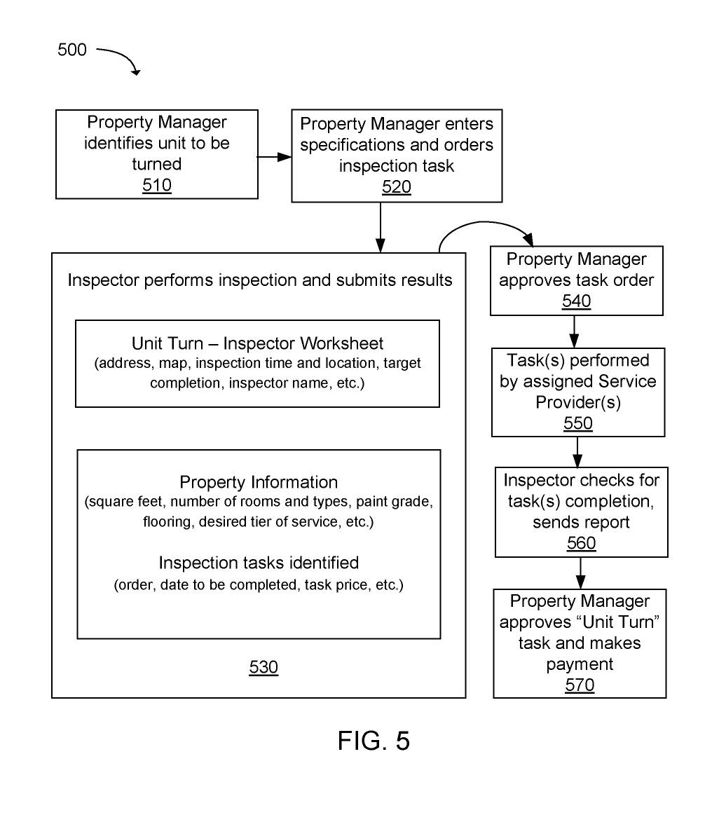

A very specific example 500 of the unit-turn task is shown in FIG. 5. In that FIG., a project manager is used on behalf of the customer, but the project manager can likewise be the owner, a property manager, or any other project manager or person that orders and follows up on the services for the property owner. In this example, a property manager identifies 510 a unit to be inspected, and fills out know specifications and orders a task 520. The inspector then fills out an inspection worksheet (electronically) 530, including any information that may be needed that was not included by the property manager. Once the information is filled out and uploaded, the property manager can then approve the tasks 540. Upon completion of the tasks 550, the inspector verifies that the tasks were completed 560, such as to industry standards, and the property manager approves the unit-turn and payment 570. Other variations of this unit-turn flow can also be carried out as would be appreciated by one skilled in the art after considering the present disclosure.

In another aspect of the present disclosure, after a period of time with an inspector and a specific customer, the inspections should become more efficient and get better with time. For example, if a customer is consistently asking for the same inspection service, and the inspector is continually recommending the same tasks to be completed, there may be a time where the initial inspection becomes unnecessary, whereas the follow-up inspections would presumably remain intact. Furthermore, there may be meta-data that is not available when the task is ordered the first time, and once specified by the inspector, never needs to be specified again (e.g. how many square feet of wall space needs to be painted, is the paint 1-tone, 2-tone, or 3-tone, etc). In fact, in some cases, this might allow for the complete removal of the inspector from the workflow. By removing the inspector from the equation (at least in part), this can reduce the overall cost to the customer going forward.

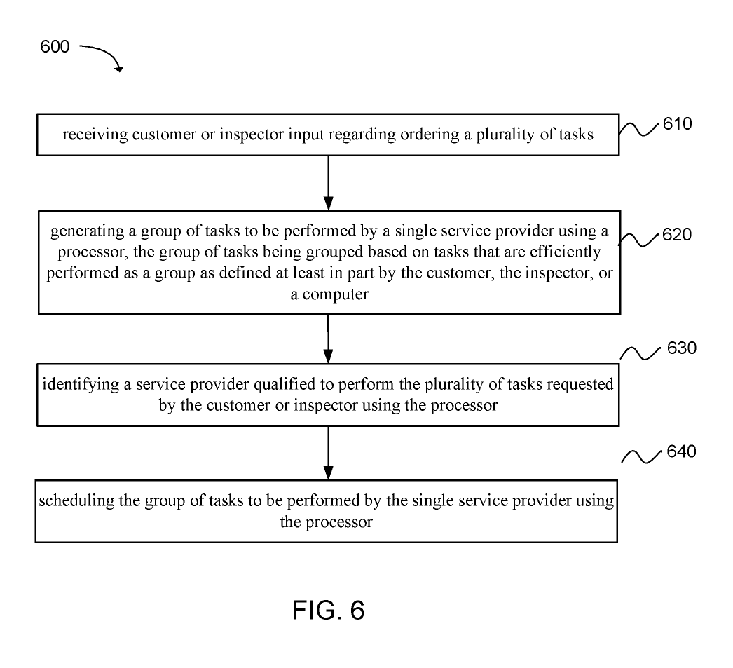

In another example, a method 600 for assigning tasks to a single service provider is set forth in FIG. 6. The method can include multiple steps, including receiving 610 customer or inspector input regarding ordering a plurality of tasks; generating 620 a group of tasks to be performed by a single service provider using a processor, the group of tasks being grouped based on tasks that are efficiently performed as a group as defined at least in part by the customer, the inspector, or a computer; identifying 630 a service provider qualified to perform the plurality of tasks requested by the customer or inspector using the processor; and scheduling 640 the group of tasks to be performed by the single service provider using the processor.

With this method, increased efficiencies to the service provider can be generated. Exemplary increased efficiencies may include a reduction in fuel cost, travel time, setup time, or cleanup time. Additionally, cost savings can also be realized compared to scheduling each of the tasks separately.

There are several parameters that can be used to group related tasks, including receiving input from the customer, receiving relevant grouping information from the inspector, or using computer algorithms to determine appropriate grouping information.

In further detail, there are a variety of instances were a plurality of tasks might be desired and yet it is deemed to be more efficient to have a single service provider perform those tasks. A common example of this is when a property manager needs to prepare a rental unit in advance of its being occupied by a new tenant. Frequently, preparing a unit, such as for the unit-turn described previously, is done by a single maintenance person, plus a handful of outside service providers. The maintenance person might be responsible for a plurality of tasks including such things as: washing the windows, housecleaning, touch up painting, carpet cleaning, fixing plumbing leaks, fixing or replacing appliances, and/or replacing or rekeying locks.

In accordance with embodiments of the present disclosure, the computer system can allow the customer to specify that certain tasks should be grouped together and assigned to single service providers according to rules that the customer creates or according to computer system defaults. In many cases, specialization of service providers might result in profound cost savings, time savings, and/or quality improvements. For example, painting is a skilled labor and a service provider who spends the bulk of his time painting will likely perform higher quality work in a shorter amount of time then a jack-of-all-trades “handyman.”

Thus, in one example, the computer system tracks performance times and quality levels based on customer feedback of each service provider for each task performed. The computer system can also detect a difference between a service provider who specializes in a particular task versus a handyman, based on the average amount of time a service provider spends on similar tasks. Someone who specializes would likely perform identical tasks more quickly than someone that is not specialized. The computer system can make determinations as to whether it is more efficient to use a specialized service provider for one task or multiple tasks by computing the intersection of the time it takes to perform the individual tasks and the time it takes to move from one task to another task either at the same location or at multiple locations. For example, if it takes a specialized service provider 30 minutes to perform a painting task, it might take a non-specialized handyman 60 minutes to perform that same task. Thus, it may be typically better to use the specialized service provider. However, if the estimated travel time for the non-specialized handyman is 1 minute, whereas the specialized service provider has an estimated 45 minutes of travel in each direction, it suddenly better to use the non-specialized service provider, assuming that the resulting work will be of the same quality. The computer processor or system can take these factors into account when assigning out tasks.

The computer system may perform hundreds or even millions of such calculations each time a group of tasks is requested by a customer. The computer system can then determine whether it is more efficient to have a non-specialized handyman perform multiple tasks, specialized service providers perform each task, or some combination of non-specialized and specialized service providers. The computer system may also consider other efficiencies that might be achieved through the combination of tasks. For example, some tasks may have waiting periods (e.g. allowing caulking, painting, or glue to dry) which would allow that service provider to perform other tasks during the waiting period.

Customers may have other reasons for wanting tasks to be logically grouped together and not assigned to specialized service providers. For example, full-time employees or staff are often considered fixed or sunk costs, keeping them busy is of utmost importance, even if it is less expensive to have a specialized service provider perform the work, full-time staff cost does not go away. Customers can specify that they want the computer system to maximize optimizations with or without the utilization of full-time staff.

In further detail regarding all of the methods of the present disclosure, any of the steps can be performed in a number of sequences and are not intended to be limited to the order written. However, the order for each method given is also explicitly disclosed as a single embodiment of the various methods. Additionally, it is noted that any and all combinations of such steps or individual step may be performed sequentially or simultaneously. Still further, it is noted that various process or method steps are described in the context of a single method embodiment. However, it is noted that any of the description details from a single system or method embodiment is also be applicable to other methods or systems described herein. For example, the inspection descriptions can also relate to the methods generally described in FIGS. 2 and 6, even though inspection is described specifically in FIGS. 4 and 5.

The term “in a computing environment” is meant to include steps that are carried out by a computer using a processor. In certain examples, some or all steps where there is input, processing, or output from a processor can be considered to be performed “in a computing environment.” These steps can be comingled with steps performed by humans that utilize the computing environment (and the processor). Furthermore, when using the terms “a processor” or “the processor,” this does not infer that the same exact processor is used for any two method steps. Multiple processors working together should be considered to be “a processor” or “the processor.”

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. In a computing environment, a method for allowing a customer to procure tasks as a single package, the method comprising:
displaying a plurality of tasks and high-level parameters related to the tasks;
receiving input to configure the high-level parameters with respect to the tasks;
incorporating meta-data parameters with the high-level parameters using the processor;
determining a fixed price for performing one or more of the tasks using the processor; and
receiving input from the customer for ordering one or more of the tasks.

2. The method of claim 1, wherein the high-level parameters include one or both of the frequency of service or quality of service.

3. The method of claim 1, wherein the high-level parameters include a sporadic service preference based on an environmental condition or unexpected vacancy of a property unit.

4. The method of claim 1, further comprising the step of initiating a service order for an inspection to be conducted by an inspector before a task implemented or after a tasked has been completed.

5. The method of claim 1, wherein the tasks are related to one or more properties that are also displayed along with the tasks and high-level parameters.

6. The method of claim 5, further comprising the step of assigning one or more of the tasks at one or more of the properties to a service provider's schedule.

7. The method of claim 5, wherein the tasks are related to multiple properties controlled by a common customer.

8. The method of claim 7, wherein the multiple properties include a list of units within a single property, or a list of multiple units over multiple properties.

9. The method of claim 7, wherein the plurality of tasks are facilitated over a reduced time interval for a rental property unit-turn.

10. The method of claim 7, wherein the plurality of tasks includes the same task repeated over multiple properties or multiple units.

11. In a computing environment, a method for allowing a customer to procure services with the assistance of an inspector, the method comprising:
initiating a service order for an inspection to be conducted by an inspector;
receiving input from the inspector specifying one or more tasks to be performed once the inspector has inspected a task site;
computing fixed prices for the one or more tasks to be performed using a processor; and
identifying one or more service providers to perform the one or more tasks using the processor.

12. The method of claim 11, further comprising the step of obtaining approval from the customer to perform one or more tasks after receiving input for the inspector.

13. The method of claim 11, further comprising the steps of receiving input from the one or more service providers indicating that the one or more tasks have been completed.

14. The method of claim 13, further comprising the step of notifying the inspector or a different inspector to return to the work site once the one or more tasks have been completed to verify that the one or more tasks have been properly performed using the processor.

15. The method of claim 14, further comprising the step of receiving input from the inspector or the different inspector that the one or more tasks were properly performed.

16. The method of claim 14, further comprising the steps of:
receiving input from the inspector or different inspector indicating that the one or more tasks were not properly specified, not performed, or not properly performed; and
creating one or more remediation procedures to remedy any of the one or more tasks that was not properly specified, not performed, or not properly performed using the processor.

17. The method of claim 16, wherein the one or more remediation procedures includes refund or partial refund to the customer, or return of a service provider to a site of the task to complete the task properly.

18. The method of claim 13, further comprising the steps of:
receiving input from the one or more service providers indicating that the inspection or a task performed by another service provider was not properly specified, not performed, or not properly performed; and
creating one or more remediation procedures to remedy the inspection or task that was not properly specified, not performed, or not properly performed using the processor using the processor.

19. The method of claim 18, wherein the one or more remediation procedures includes refund to the customer, or return of a service provider to a site of the task to complete the task properly.

20. The method of claim 11, wherein the tasks are procured by the customer during a single computing session.

21. The method of claim 11, wherein the step of computing fixed prices is based on one or more of:
data provided by the inspector;
data provided by the customer; and
third party data that is obtained about the task.

22. The method of claim 21, wherein the step of computing fixed prices is based at least in part on the third party data, and the third party data is selected from the group consisting of weather data or data stored in a database.

23. The method of claim 11, wherein tasks to be performed are set up according to industry standards and expectations based on the inspection.

24. The method of claim 11, wherein the inspector specifies an order in which the one or more tasks are to be performed as the order relates to at least two specific tasks.

25. The method of claim 11, wherein the inspector that performs the inspection is not permitted to be a service provider for any of the tasks.

26. The method of claim 11, wherein the method facilitates a reduction in time for unit-turn of a rental property.

27. The method of claim 11, wherein the step of receiving input from the inspector is by an electronically uploaded inspector worksheet filled out by the inspector.

28. The method of claim 11, wherein the step of initiating the service order is by a project manager or property owner who overseas unit-turn for a rental unit, and wherein the method further comprises additional steps of the project manager or property owner approving the unit-turn and authorizing payment.

29. The method of claim 11, wherein the method is conducted multiple times by the same inspector at multiple properties or property units.

30. The method of claim 26, wherein at some point after the method is carried out a first time on a first property or property unit, the steps of initiating the service order for the inspection and receiving input from the inspector are not carried out on a subsequent property or property unit.

31. In a computing environment, a method for assigning tasks to a single service provider, the method comprising:
receiving customer or inspector input regarding ordering a plurality of tasks;
generating a group of tasks to be performed by a single service provider using a processor, the group of tasks being grouped based on tasks that are efficiently performed as a group as defined at least in part by the customer, the inspector, or a computer;
identifying a service provider qualified to perform the plurality of tasks requested by the customer or inspector using the processor; and
scheduling the group of tasks to be performed by the single service provider using the processor.

32. The method of claim 31, wherein the method provides for increased efficiencies to the service provider.

33. The method of claim 31, wherein the increased efficiencies include a reduction in fuel cost, travel time, setup time, or cleanup time.

34. The method of claim 31, wherein the method provides cost savings to the customer compared to scheduling each task separately.

35. The method of claim 31, wherein the group of tasks are grouped at least in part by the customer.

36. The method of claim 31, wherein the group of tasks are grouped at least in part by the inspector.

37. The method of claim 31, wherein the group of tasks are grouped at least in part by the computer.
